(19) United States
(12) Patent Application Publication
(10) Pub. No.: US 2025/0277172 A1
(43) Pub. Date: Sep. 4, 2025

(54) CLEANING PRODUCT WITH ADHESIVE-INHIBITING PROPERTIES

(71) Applicant: KICTeam, Inc., Auburn, ME (US)

(72) Inventors: John Condon, Sumner, ME (US); Kenneth Monroe Pederson, III, Auburn, ME (US); Eliza M. Kessler, North Princeton, MA (US); Edward H. Cheesman, Lunenburg, MA (US)

(21) Appl. No.: 19/069,781

(22) Filed: Mar. 4, 2025

Related U.S. Application Data
(60) Provisional application No. 63/561,047, filed on Mar. 4, 2024.

(51) Int. Cl. C11D 7/50; B08B 1/14; B08B 13/00; B41J 3/407; B41J 29/17; C11D 7/26

(52) U.S. Cl. CPC C11D 7/5022; B08B 1/143; B08B 13/00; B41J 3/4075; B41J 29/17; C11D 7/263

(57) ABSTRACT

Provided are cleaning medium and a cleaning card impregnated, coated, treated or saturated with or including cleaning medium and more specifically to cleaning medium and cleaning cards having the capability of cleaning internal surfaces of machine-actuating mechanisms. The cleaning medium may include ethanol and tripropylene glycol n-butyl ether (TGBE). The TGBE may be present in an amount of about 50-70% by weight based on the total weight of the cleaning medium.

### CROSS-REFERENCE TO RELATED APPLICATIONS

This application claims priority under 35 U.S.C. § 119(e) to U.S. Provisional Patent Application No. 63/561,047, filed on Mar. 4, 2024, the entire contents of which are hereby incorporated by reference.

### TECHNICAL FIELD

This disclosure relates generally to a cleaning medium and a cleaning card impregnated, coated, treated, or saturated with or including a cleaning medium and more specifically to a cleaning medium and cleaning cards having the capability of cleaning internal surfaces of machine-actuating mechanisms such as reading mechanisms in label printers, linerless label printers, ATM machines, vending machines including slots for receiving paper currency, turnstile machines including slots for receiving a token or card including a magnetic stripe, and a variety of other machines including reading mechanisms having internal surfaces that require cleaning. These machines often process media that can carry various forms of debris, adhesive residue, or foreign particles, making an effective cleaning solution and method essential for sustained operational reliability.

### BACKGROUND

Numerous machines are equipped with media transport mechanisms designed to intake and/or expel printed media, guiding it through various sections to undergo diverse processes. For instance, a financial transaction terminal, such as an automated teller machine, may execute any or all of the following tasks: (i) receiving printed currency notes, checks, receipts, coupons, tickets, and other printed media; (ii) aligning the media to an internal reference; (iii) utilizing a camera and/or other sensors to identify the content and/or printing on the media; (iv) applying additional printed markings to the media; and/or (v) directing the media to a suitable shuttle, bin, or exit port. The terminal may execute some or all of these tasks, along with potential additional steps. Other machines incorporating media transport mechanisms encompass transaction card readers, coupon printers, ticket printers, linerless label printers, ticket-taking devices, and various systems for handling printed media. Many of these tasks rely heavily on precise mechanical and optical components that can be compromised when contaminants build up on surfaces such as rollers, reading heads, or cutting blades.

Because transaction cards, currency, and other media that passes through such machines can be handled by human hands and can be exposed to various environmental conditions, the insertion of a card or other media into a media transport device also introduces dirt, oil and/or other contaminants into the device. When such contaminants touch the device's contacts and other components such as a reading head, it can impair the device's ability to collect data from the card. Over time, the contaminants can build up on the contacts and other components, and they may cause the device to malfunction. Moreover, label printers—particularly linerless label printers—are susceptible to adhesive residue accumulation on rollers and cutting mechanisms, which can lead to jams, poor print quality, or slippage of the label stock.

Thus, a significant need persists for a chemical cleaning composition and product that offers solution compatibility, cleanability, low flammability, prolonged efficacy, and regulatory compliance, as well as advantages in health and safety for cleaning the internal surfaces of machine-actuating mechanisms. Such a formulation should effectively remove debris while remaining gentle on sensitive substrates like rubber rollers and silicone components, reducing downtime and maintenance costs.

This disclosure describes methods, products, and systems directed to solving some of the issues described above, and/or other issues. By providing a specialized cleaning medium and an associated cleaning card or substrate, these embodiments enable routine or preventative maintenance to ensure optimal performance and extended service life for a wide variety of machines handling printed or encoded media.

### SUMMARY

The above and other objects of this disclosure are achieved in a cleaning medium and cleaning cards impregnated, coated, treated or saturated with or including the cleaning medium designed for use in cleaning internal surfaces of a media transport device.

In example embodiments, a cleaning medium for removing or dissolving adhesive or debris is provided. The cleaning medium includes ethanol and tripropylene glycol n-butyl ether (TGBE). The cleaning medium may consist essentially of ethanol TGBE. The TGBE may be present in an amount of about 50-65% by weight based on the total weight of the cleaning medium. The ethanol may be present in an amount of about 35-50% by weight based on the total weight of the cleaning medium. Optionally, the TGBE may be present in an amount of about 51% by weight and the ethanol is present in an amount of about 49% by weight based on the total weight of the cleaning medium. Optionally, an amount of the TGBE may be more than an amount of the ethanol by weight.

The TGBE may include tripropylene glycol monobutyl ether, propylene glycol monobutyl ether and tripropylene glycol. The cleaning medium may further include dipropylene glycol n-butyl ether.

In some embodiments, the tripropylene glycol monobutyl ether may be present in an amount of more than about 95%, about 96%, about 97%, about 98%, or about 99% by weight based on a total weight of the tripropylene glycol monobutyl ether, propylene glycol monobutyl ether, tripropylene glycol, and dipropylene glycol n-butyl ether.

In some embodiments, except tripropylene glycol monobutyl ether and ethanol, propylene glycol monobutyl ether may be the most contained chemical by weight.

In some embodiments, the cleaning medium may be free of limonene. The cleaning medium may be free of isopropyl alcohol (IPA). The cleaning medium may be free of dipropylene glycol methyl ether acetate. The cleaning medium may be free of silicone. The cleaning medium may be free of any of limonene, IPA, silicone, or dipropylene glycol methyl ether acetate.

In some embodiments, the cleaning medium may be substantially free of limonene. The cleaning medium may be substantially free of isopropyl alcohol (IPA). The cleaning medium may be substantially free of dipropylene glycol methyl ether acetate. The cleaning medium may be substantially free of silicone. The cleaning medium may be substantially free of any of limonene, IPA, silicone, or dipropylene glycol methyl ether acetate.

In some embodiments, a cleaning tool for use in cleaning internal surfaces of a machine-actuating mechanism intended to receive an operating card or other machine-operating substrates is provided. The cleaning card may include a cleaning substrate impregnated, coated, treated or saturated with or including a cleaning medium, and the cleaning medium may include ethanol and tripropylene glycol n-butyl ether (TGBE). The TGBE may be present in an amount of about 50-70% by weight based on the total weight of the cleaning medium. The ethanol may be present in an amount of about 30-50% by weight based on the total weight of the cleaning medium.

The TGBE may include propylene glycol monobutyl ether and tripropylene glycol. The cleaning medium may further include dipropylene glycol n-butyl ether. In some embodiments, the TGBE may be present in an amount of more than about 95% by weight based on a total weight of the TGBE, propylene glycol monobutyl ether, tripropylene glycol, and dipropylene glycol n-butyl ether.

In some embodiments, a method of cleaning a label printer includes treating a cleaning substrate with a cleaning solution comprising ethanol and tripropylene glycol n-butyl ether (TGBE); inserting the treated cleaning substrate into a transport path of the label printer so as to come into contact with at least one internal surface when the printer is activated; activating the label printer to cause the at least one internal surface to contact the treated substrate; and removing the cleaning substrate from the transport path. The method may further comprise repeating the activating step at additional locations on the cleaning substrate to enhance contact between the internal surface and the cleaning solution as the substrate moves along the transport path. The method may also comprise sensing a condition of the label printer after removing the cleaning substrate to determine whether adhesive residue remains on the at least one internal surface, and repeating the treating, inserting, and activating steps if adhesive residue is detected. The method may specify that the TGBE is present in the cleaning solution in an amount of about 50-70% by weight and the ethanol is present in the cleaning solution in an amount of about 30-50% by weight, based on the total weight of the cleaning solution.

### BRIEF DESCRIPTION OF THE DRAWINGS

FIG. 1 is an illustration of an example cleaning card in which at least one cleaning surface includes a cleaning medium in accordance with some embodiments of the present disclosure.

FIG. 2 is a side view of the example cleaning card of FIG. 1.

FIG. 3 is a schematic cross-sectional view of an example multi-layer cleaning card.

FIG. 4 is a flowchart illustrating an example label-printer cleaning process.

### DETAILED DESCRIPTION

The following description is made for the purpose of illustrating the general principles of the present devices and/or methods and is not meant to limit the inventive concepts claimed in this disclosure. Further, particular features described in this disclosure can be used in combination with other described features in each of the various possible combinations and permutations.

Unless otherwise specifically defined in this disclosure, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. Unless defined otherwise, all technical and scientific terms used herein have the same meanings as commonly understood by one of ordinary skill in the art. All publications mentioned in this disclosure are incorporated by reference. Nothing in this disclosure is to be construed as an admission that the embodiments described in this disclosure are not entitled to antedate such disclosure by virtue of prior invention. As used herein, the term “comprising” means “including, but not limited to”.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “linerless label printer” used herein refers to a label printing device that dispenses labels without a separate release liner. Instead, the printed labels are wound or fed on a continuous roll where the backing material is coated, treated, or otherwise configured so that it does not require a separate liner.

The term “traditional label printer” used herein refers to a label printing device that dispenses labels on a release liner (or backing paper) from which individual labels are peeled before application.

The term “machine-actuating mechanism” used herein refers to any component or assembly in a machine (e.g., printer, currency dispenser, card reader) that moves, guides, actuates, or otherwise interacts with a substrate such as paper, labels, or cards for processing.

The term “internal surface” used herein refers to any inward-facing surface or component of a machine that makes contact with, or is in proximity to, media (e.g., currency, labels, tickets, cards) passing through the machine. Examples include rollers, print heads, cutting blades, belts, guides, reading heads, and media-transport paths.

The term “cutting blade” used herein refers to a blade or knife mechanism within a label printer (or other media handling device) that severs, trims, or separates media or labels during operation.

The term “adhesive residue” used herein refers to any sticky accumulation, film, or deposit remaining on a surface after repeated contact with adhesives, such as those on labels or other media. This residue can cause malfunctions, jams, or reduced performance in media-handling devices.

The term “prolonging effect” used herein refers to the ability of the disclosed cleaning solution to remain on or within a surface for a period of time, thereby continuing to inhibit or prevent the accumulation of adhesive or debris between cleaning sessions.

The term “swelling” used herein refers to dimensional changes (e.g., increases in length, width, or thickness) of a component, such as a rubber roller or silicone part, upon exposure to a solvent or chemical composition.

The term “media transport system” used herein refers to the collection of components (e.g., rollers, belts, feed paths, sensors) in a device that moves or handles paper, labels, tickets, currency, or other media through one or more processing steps.

The term “adhesive-inhibiting” used herein refers to the capability of a composition, surface treatment, or substrate to reduce or prevent the buildup of adhesive on a surface over time.

As used herein, the phrase “consists essentially of” means excluding other materials that contribute to adhesive or debris removal functions. The objective of the medium and the cleaning card impregnated, coated, treated or saturated with or including the medium is to clean and remove adhesive or debris on internal surfaces of a machine-actuating mechanism that interferes with the operation of the mechanism intended to receive an operating card or other machine-operating substrates. Other materials that contribute to the cleaning function that materially affect the basic and novel characteristics of the present disclosure are not required and are potentially counterproductive because they may remain on the surface and adversely affect the adhesive or debris removal functions. In other words, the meaning of “consists essentially of” is tied to the objective and excludes materials (that contribute to the cleaning functions) that materially affect the cleaning or adhesive or debris removal function of the medium. Small traces that have little or no effect to the function of the medium as part of the embodiments of the present disclosure may exist in a medium that consists essentially of ethanol and tripropylene glycol n-butyl ether (TGBE) or dipropylene glycol n-propyl ether (DPnP) under the definition because it would not materially affect its function and/or objective.

As used herein, the phrase “free of” means 0% by weight or in a non-detectable amount. For example, the medium substantially free of limonene means that the product has less than 1% by weight, optionally less than 0.1% by weight, based on the total weight of the medium, of limonene.

As used herein, the term “substantially free of” means less than 1% by weight, optionally less than 0.1% by weight. For example, the medium substantially free of limonene means that the product has less than 1% by weight, optionally less than 0.1% by weight, based on the total weight of the medium, of limonene.

As used herein, the term “medium” means a solution, solvent, suspension, dispersion, or emulsion that cleans and removes adhesive or debris on internal surfaces of a machine-actuating mechanism that interferes with the operation of the mechanism intended to receive an operating card or other machine-operating substrates.

As used herein, the term “denatured ethanol” means ethanol containing small amounts of methanol, typically up to about 5% v/v. methanol, such as from about 0.9 to 5% v/v methanol, for example ethanol containing about 4% v/v methanol.

As used herein, the term “tripropylene glycol n-butyl ether” means CAS number 55934-93-5.

As used herein, the term “propylene glycol monobutyl ether” means CAS number 5131-66-8.

As used herein, the term “tripropylene glycol” means CAS number 24800-44-0.

As used herein, the term “dipropylene glycol n-butyl ether” means CAS number 29911-28-2.

As used herein, the term “dipropylene glycol n-propyl ether” means CAS number 29911-27-1.

As used herein, the term “limonene” means CAS number 138-86-3.

As used herein, the term “isopropyl alcohol” means CAS number 67-63-0.

As used herein, the term “polydimethylsiloxane” means CAS number 9006-65-9.

In some embodiments, a cleaning medium for removing adhesive or debris includes ethanol and tripropylene glycol n-butyl ether (TGBE). In some embodiments, a cleaning medium for removing adhesive or debris consists essentially of ethanol and tripropylene glycol n-butyl ether (TGBE). In some embodiments, a cleaning medium for removing adhesive or debris consists of ethanol and tripropylene glycol n-butyl ether (TGBE). The combination of ethanol and TGBE has been found to both dissolve contaminants effectively and minimize residue formation on printer components, including roller surfaces and reading heads.

The TGBE may be present in an amount of about 50-70% by weight based on the total weight of the cleaning medium. In some embodiments, the TGBE may be present in an amount of about 50-65% by weight based on the total weight of the cleaning medium. More than about 65% of TGBE may not show great cleanability. In some embodiments, the TGBE may be present in an amount of more than about 50% by weight based on the total weight of the cleaning medium. In some embodiments, the TGBE may be present in an amount of about 51% by weight based on the total weight of the cleaning medium. Optionally, the TGBE may be present in an amount of about 51-65% by weight based on the total weight of the cleaning medium. A relatively higher TGBE concentration (above 50% by weight) can enhance the solvent power against adhesive residues, yet retain enough ethanol to ensure quick drying and reduced streaking.

The ethanol may be present in an amount of about 30-50% by weight based on the total weight of the cleaning medium. Optionally, the ethanol may be present in an amount of about 35-50% by weight based on the total weight of the cleaning medium. Less than about 35% of ethanol and more than about 65% TGBE may not show great cleanability. In some embodiments, the TGBE may be present in an amount of about 50% by weight based on the total weight of the cleaning medium. In some embodiments, the TGBE may be present in an amount of about 51% by weight based on the total weight of the cleaning medium. In some embodiments, ethanol may be denatured ethanol. Denatured ethanol, in particular, provides a balance of rapid evaporation and effective contaminant softening, aiding quick cleaning cycles where minimal dwell time is desirable.

In some embodiments, the TGBE may be present in an amount of more than about 50% by weight and the ethanol is present in an amount of less than about 50% by weight based on the total weight of the cleaning medium. In some embodiments, the TGBE may be present in an amount of about 51% by weight and the ethanol is present in an amount of about 49% by weight based on the total weight of the cleaning medium. In some embodiments, the TGBE may be present in an amount of about 50% by weight and the ethanol is present in an amount of about 50% by weight based on the total weight of the cleaning medium. Balancing the ratio near 50:50 ensures a straightforward formulation that is both potent and safe for sensitive printer components, while avoiding excessive odor or flammability.

The cleaning medium may include propylene glycol monobutyl ether and tripropylene glycol. The cleaning medium may further include dipropylene glycol n-butyl ether. Optionally, the TGBE may be present in an amount of more than about 95% by weight based on a total weight of the TGBE, propylene glycol monobutyl ether, tripropylene glycol, and dipropylene glycol n-butyl ether.

Optionally, propylene glycol monobutyl ether may be present in an amount of less than about 4% by weight based on a total weight of the TGBE, propylene glycol monobutyl ether, tripropylene glycol, and dipropylene glycol n-butyl ether.

Optionally, tripropylene glycol may be present in an amount of less than about 1.9% by weight based on a total weight of the TGBE, propylene glycol monobutyl ether, tripropylene glycol, and dipropylene glycol n-butyl ether.

Optionally, dipropylene glycol n-butyl ether may be present in an amount of less than about 1.5% by weight based on a total weight of the TGBE, propylene glycol monobutyl ether, tripropylene glycol, and dipropylene glycol n-butyl ether.

In some embodiments, an amount of the TGBE, glycol monobutyl ether, tripropylene glycol, and dipropylene glycol n-butyl ether may be more than an amount of the ethanol by weight.

In some embodiments, TGBE consists of tripropylene glycol monobutyl ether. In some embodiments, TGBE consists of tripropylene glycol monobutyl ether and polypropylene glycol monobutyl ether. In some embodiments, TGBE consists of tripropylene glycol monobutyl ether, polypropylene glycol monobutyl ether, and tripropylene glycol. In some embodiments, TGBE consists of tripropylene glycol monobutyl ether, polypropylene glycol monobutyl ether, tripropylene glycol, and dipropylene glycol n-butyl ether.

In some embodiments, TGBE consists essentially of tripropylene glycol monobutyl ether. In some embodiments, TGBE consists essentially of tripropylene glycol monobutyl ether and polypropylene glycol monobutyl ether. In some embodiments, TGBE consists essentially of tripropylene glycol monobutyl ether, polypropylene glycol monobutyl ether, and tripropylene glycol. In some embodiments, TGBE consists essentially of tripropylene glycol monobutyl ether, polypropylene glycol monobutyl ether, tripropylene glycol, and dipropylene glycol n-butyl ether.

In some embodiments, TGBE comprises tripropylene glycol monobutyl ether. In some embodiments, TGBE comprises tripropylene glycol monobutyl ether and polypropylene glycol monobutyl ether. In some embodiments, TGBE comprises tripropylene glycol monobutyl ether, polypropylene glycol monobutyl ether, and tripropylene glycol. In some embodiments, TGBE comprises tripropylene glycol monobutyl ether, polypropylene glycol monobutyl ether, tripropylene glycol, and dipropylene glycol n-butyl ether.

In some embodiments, tripropylene glycol monobutyl ether is present in an amount of about 95% by weight of TGBE. In some embodiments, tripropylene glycol monobutyl ether is present in an amount of about 96% by weight of TGBE. In some embodiments, tripropylene glycol monobutyl ether is present in an amount of about 97% by weight of TGBE. In some embodiments, tripropylene glycol monobutyl ether is present in an amount of about 98% by weight of TGBE. In some embodiments, tripropylene glycol monobutyl ether is present in an amount of about 99% by weight by weight of TGBE.

In some embodiments, a cleaning medium for removing adhesive or debris includes ethanol and dipropylene glycol n-propyl ether (DPP). DPnP can serve as a complementary or alternative approach to TGBE when certain regulatory or safety constraints arise, providing similar adhesive-removal benefits with minimal negative impact on elastomeric printer components. In some embodiments, a cleaning medium for removing adhesive or debris consists essentially of ethanol and dipropylene glycol n-propyl ether (DPnP). In some embodiments, a cleaning medium for removing adhesive or debris consists of ethanol and dipropylene glycol n-propyl ether (DPnP).

The dipropylene glycol n-propyl ether (DPnP) may be present in an amount of about 50-70% by weight based on the total weight of the cleaning medium. In some embodiments, the dipropylene glycol n-propyl ether (DPP) may be present in an amount of about 50-65% by weight based on the total weight of the cleaning medium. More than about 65% of dipropylene glycol n-propyl ether (DPnP) may not show great cleanability. In some embodiments, the dipropylene glycol n-propyl ether (DPnP) may be present in an amount more than about 50% by weight based on the total weight of the cleaning medium. In some embodiments, the dipropylene glycol n-propyl ether (DPnP) may be present in an amount of about 51% by weight based on the total weight of the cleaning medium.

The ethanol may be present in an amount of about 30-50% by weight based on the total weight of the cleaning medium. In some embodiments, the ethanol may be present in an amount of about 35-50% by weight based on the total weight of the cleaning medium. Less than 35% of ethanol and more than about 65% dipropylene glycol n-propyl ether (DPnP) may not show great cleanability. In some embodiments, the dipropylene glycol n-propyl ether (DPnP) may be present in an amount of more than about 50% by weight based on the total weight of the cleaning medium. In some embodiments, the dipropylene glycol n-propyl ether (DPnP) may be present in an amount of about 51% by weight based on the total weight of the cleaning medium. In some embodiments, ethanol may be denatured ethanol.

In some embodiments, the dipropylene glycol n-propyl ether (DPnP) may be present in an amount of more than about 50% by weight and the ethanol is present in an amount of less than about 50% by weight based on the total weight of the cleaning medium. In some embodiments, the dipropylene glycol n-propyl ether (DPnP) may be present in an amount of about 51% by weight and the ethanol is present in an amount of about 49% by weight based on the total weight of the cleaning medium. In some embodiments, the dipropylene glycol n-propyl ether (DPnP) may be present in an amount of about 50% by weight and the ethanol is present in an amount of about 50% by weight based on the total weight of the cleaning medium.

In some embodiments, a cleaning medium for removing adhesive or debris includes ethanol, TGBE, and DPnP. In some embodiments, TGBE and DPnP may be present in an amount of more than about 50% by weight and the ethanol is present in an amount of less than about 50% by weight based on the total weight of the cleaning medium. In some embodiments, TGBE and DPnP may be present in an amount of about 51% by weight and the ethanol is present in an amount of about 49% by weight based on the total weight of the cleaning medium. In some embodiments, TGBE and DPnP may be present in an amount of about 50% by weight and the ethanol is present in an amount of about 50% by weight based on the total weight of the cleaning medium.

In some embodiments, the cleaning medium may be free of any element or component that may negatively affect the function of removing or dissolving adhesive or debris or may be incompatible with or deform the cleaning surface(s) of the cleaning card. For example, the cleaning medium may be free of limonene. The cleaning medium may be free of isopropyl alcohol (IPA). The cleaning medium may be free of silicone (e.g., polydimethylsiloxane). The cleaning medium may be free of dipropylene glycol methyl ether acetate. The cleaning medium may be free of any of limonene, IPA, silicone, or dipropylene glycol methyl ether acetate.

In some embodiments, a cleaning tool for use in cleaning internal surfaces of a media transport system, such as one designed to receive an operating card or other machine-operating substrates is provided. The cleaning tool may include a cleaning substrate impregnated, coated, treated or saturated with or including a cleaning medium described herein. The cleaning medium may be applied to or included in the cleaning card by any suitable method.

For example, the cleaning substrate may include but not be limited to cellulose/polyester, microfiber, polyester blends, other non-wovens. In some embodiments, the cleaning substrate may provide a cleaning surface that includes an unbroken loop material (e.g., a UBL product). Empirical testing shows that UBL (unbroken loop) materials deliver a uniform application of the cleaning medium to printer surfaces, helping to loosen debris in crevices or textured areas. Additionally, using cellulose/polyester blends can offer strong absorbency yet remain gentle on sensitive surfaces like silicone rollers. The inventors have surprisingly found that combination of TGBE or DPnP with a UBL product to be highly effective for cleaning platen rollers in label printers or linerless label printers. The solution, incorporating TGBE or DPnP, exhibits no deterioration of the rubber rollers. Moreover, a UBL product not only retains the solution effectively but is also less abrasive to the rubber rollers compared to other commonly used cleaning materials in printer applications.

The cleaning tool may be in forms, patterns, arrangements, or structures known in the art or field, including, but not limited to, ones described in U.S. Pat. Nos. 5,525,417, 5,227,226, 7,540,055, 7,631,390, 7,732,040, 7,846,534, 10,307,796, 11,410,003, 11,710,011, 11,816,513, 11,110,492, and U.S. Patent Application Pub. No. 2023/0256476, all of which are hereby incorporated herein by reference. Other cleaning substrates, such as wipes and towelettes, may be used in the cleaning tool in other embodiments.

In some embodiments, at least one of the cleaning faces of the tool may be coated, treated with a cleaning medium so that internal surfaces of the machine-actuating mechanism may be cleaned when the internal surfaces move along or across the cleaning face of the cleaning card. In some embodiments, two cleaning faces may be coated, treated with a cleaning medium.

In any of the embodiments described above, the cleaning card may include an absorbent material that is suitable for being impregnated, coated, treated or saturated with the cleaning medium. Optionally, the cleaning card may be made of a single material. In some embodiments, the cleaning card may include more than one layer. In some embodiments, the cleaning card may include a cleaning surface(s) and a core layer(s). In some embodiments, the cleaning card may include a cleaning surface(s), a support layer(s), and a core layer(s). A cleaning face(s) of the cleaning card may be made of an absorbent material. A support layer and/or a layer may be made of an absorbent material. Any well-known absorbent material in the art or field may be used for the purpose of being impregnated, coated, treated or saturated with the cleaning medium.

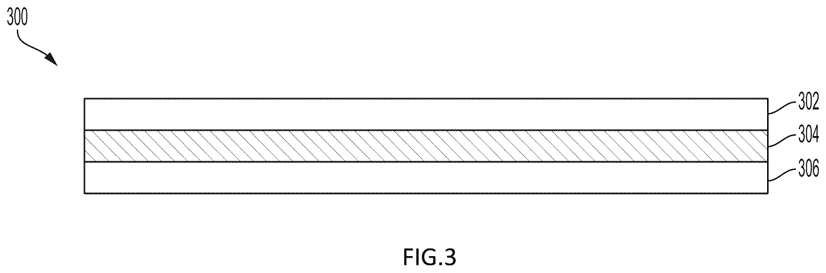

For example, some cleaning cards employ an outer layer (or layers) of absorbent cleaning material and a semi-rigid plastic core. For instance, the cleaning medium described in this document may be included in various cleaning cards in which the exterior faces (often made of unbroken loop fabric or other non-woven) retain the cleaning solution, while an internal plastic or foam core provides structural rigidity and targeted thickness. Such designs can be configured to clean a wide range of devices, from currency-counting machines to linerless label printers. In some products, the outer fabric layers are pre-saturated with the cleaning medium; in others, the user may apply the cleaning medium immediately before use. FIG. 3 (schematic illustration) shows an example cross-sectional design of a multi-layer card 300 having: (i) upper cleaning layer 302 of absorbent material; (ii) semi-rigid or rigid polymeric core 304; and (iii) lower cleaning layer 306.

Such multi-layer configurations can also be partially compressed to form raised cleaning “islands” as described, for example, in U.S. Patent Application Publication No. 2023/0256476 and U.S. patent Ser. No. 12/220,729 (which disclose shaped or embossed cleaning areas), the disclosures of which are fully incorporated into this document by reference. These raised regions can help to contact recessed or otherwise difficult-to-reach internal components of the target machine. As described herein and in these KICTeam patents, the inclusion of a rigid or semi-rigid core layer ensures that the cleaning card remains suitably stiff to pass through rollers, guides, and other actuating components, while the outer absorbent layers deliver the cleaning medium where it is most needed.

The entire contents of each of the following U.S. Patents and Applications are hereby incorporated by reference in their entirety for all purposes, to the extent permitted by applicable law: U.S. Pat. Nos. 7,540,055; 7,631,390; 7,732,040; 7,846,534; 11,816,513; 11,710,011; U.S. patent application Ser. No. 18/167,541; U.S. Patent Application Publication No. 2023/0256476; and any counterparts thereof. These documents provide additional examples of cleaning card structures, methods of partially compressing or embossing cleaning cards, multi-layer constructions (including semi-rigid cores), and various surface treatments or texturings that can be adapted for use with the cleaning medium described herein.

In any of the embodiments described above the cleaning face(s) of the cleaning card may be textured to provide additional cleaning function (e.g., by applying friction to belts that pass over the cleaning substrate). The cleaning face(s) also may include a material such as a meshed loop structure that entangles dirt to trap it. The cleaning face(s) may be made of a tear-resistant and flexible material.

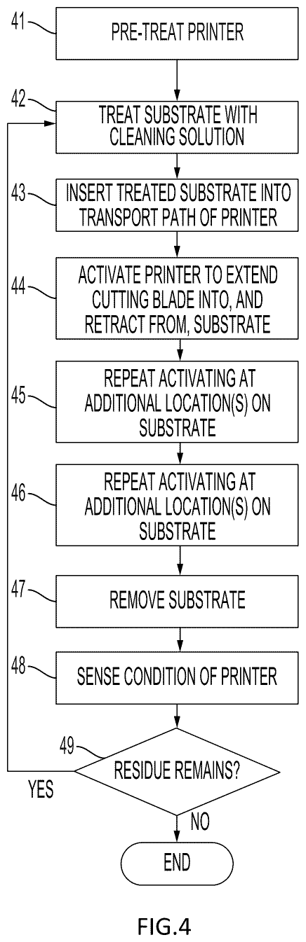

FIG. 4 is a diagram illustrating various steps of a label printer cleaning process. The method for cleaning a label printer begins with pre-treating the printer (Step 41), ensuring it is in a ready state for cleaning. Next, the substrate is treated with a cleaning and/or treatment solution (Step 42). This treatment can involve various methods such as spraying, soaking, or applying the cleaning solution through a coating method. After the substrate is adequately treated, it is inserted into the transport path of the label printer, positioning it to come into contact with the cutting blade and cutting block during printer operation (Step 43).

The printer is then activated, causing the cutting blade and cutting block to extend into the substrate and retract from it (Step 44). This process helps ensure that the cleaning and/or treatment solution contacts these components, leaving a portion of the solution on the cutting blade and cutting block after retraction. To help ensure thorough cleaning, the activation of the printer may be repeated at additional locations on the substrate as it moves along the transport path (Step 45). This can include moving the substrate to expose various parts of the substrate to the cutting blade and securing the substrate in place within the transport path for stability.

The activation process may be repeated at further additional locations on the substrate as needed to achieve comprehensive cleaning (Step 46). Once the cleaning process is deemed complete, the substrate is removed from the transport path (Step 47). The condition of the printer may then be sensed and evaluated to determine the effectiveness of the cleaning and whether any adhesive residues remain on the cutting blade or cutting block (Step 48). This may be done by manual inspection of the device or the substrate, or by automated processes such as image capturing and automated analysis of the images,

If any significant residue is detected, the cleaning process may be repeated until the printer is confirmed to be free of residue (Step 49). Once no significant residues remain, the cleaning procedure concludes, helping to ensure that the label printer is properly maintained and ready for use.

In some embodiments, the cleaning medium described herein may be used to coat or treat a cutting blade in a label printer (e.g., a linerless label printer or a traditional label printer) in order to reduce or prevent adhesive buildup over time. When label stock is cut, particularly in linerless label printers, exposed adhesive edges tend to contact the blade, leading to residue accumulation that can degrade cutting performance or cause jams.

The cleaning medium—including, for example, a solution of about 50-70 wt % tripropylene glycol n-butyl ether (TGBE) and about 30-50 wt % ethanol—may be applied to the cutting blade surface by wiping, spraying, brushing, or dipping. In some implementations, a small amount of the cleaning composition is delivered through an applicator pad or brush that is integrated into the label printer itself, automatically or periodically coating the blade during standard printer maintenance cycles.

Without being bound by theory, the relatively low volatility of TGBE, propylene glycol monobutyl ether, tripropylene glycol, and/or other glycol ethers ensures that a thin protective film remains on the blade, inhibiting subsequent adhesive buildup between cleanings. The ethanol portion assists with dissolving any existing adhesive residue. This “protective coating” effect can significantly extend the interval between maintenance operations on the blade by minimizing the rate of adhesive accumulation.

Experimental observations show that coating the blade with the disclosed cleaning medium reduces adhesive residue on the blade, helps the blade maintain a sharp cutting surface, and prevents label misfeeds. In addition, because the cleaning medium has been tested to exhibit minimal swelling or degradation of silicone or rubber materials, it does not adversely affect adjacent printer components that contact the same cleaning solution. Accordingly, this embodiment addresses a common source of downtime and maintenance expense in both traditional and linerless label printers.

In some example processes, an operator first unloads or partially opens the printer to access the cutting mechanism. The operator then uses a cloth, swab, or cleaning card impregnated with the cleaning medium to wipe the cutting blade. This step removes existing adhesive buildup and leaves a thin residual coating on the blade. The user may then allow the blade to dry briefly before closing the printer and resuming normal operation. Periodic re-application—e.g., during label-roll replacements—helps maintain low levels of buildup over extended usage.

In some embodiments the cleaning medium is placed into a small fluid reservoir or sponge-like wick within the printer. Each time the blade retracts or cycles, it contacts the saturated wick, thereby transferring a small quantity of the cleaning medium to the blade surface. This approach provides continuous or near-continuous cleansing and coating, further reducing adhesive accumulation and improving cutting consistency over time. Label printers that operate continuously can especially benefit from a light, protective film on cutting blades, minimizing downtime caused by frequent blade cleanings or adhesive clogs. Automated systems that periodically re-apply the composition to the blade ensure uninterrupted, high-volume label processing.

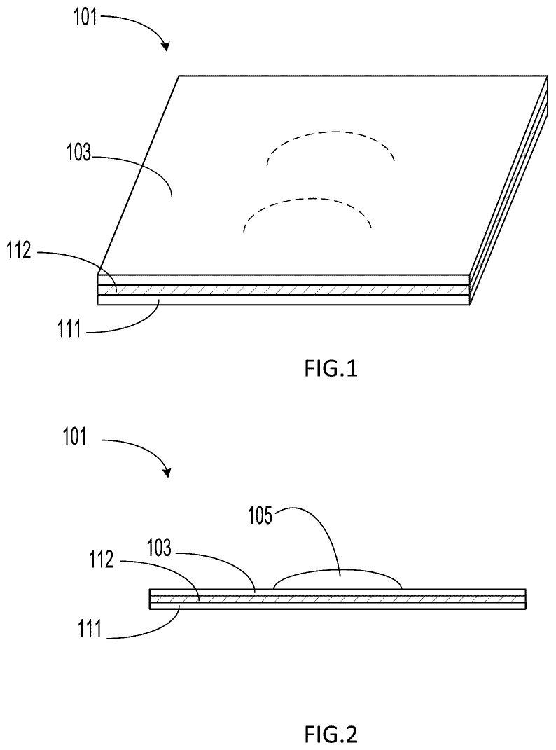

FIGS. 1 and 2 illustrate embodiments of a cleaning device 101 (sometimes referred to in this disclosure as a cleaning tool) for media transport devices such as linerless label printer. FIG. 1 shows the cleaning tool 101 from a top front perspective, while FIG. 2 shows the front of the cleaning tool. In this example, the cleaning tool is formed of a card having a planar substrate with a first cleaning surface 103 (shown as the top layer in FIGS. 1 and 2) and an opposing lower support layer 111. The support layer 111 may be made of a flexible, tear-resistant fibrous material such as a fibrous aramid or meta-aramid fabric material such as that marketed under the NOMEX® brand; a cellulosic material; or a flexible polymeric substrate provided with thin, non-woven layers made of absorbent material such as that marketed under the SONTARA® brand. The material of the support layer 111 may provide a cleaning function as the material may contact and wipe across various components of the media transport device as the cleaning tool moves into and out of the device.

The first cleaning surface 103 may be the edge of a core layer 112. Alternatively, the cleaning tool may have a distinct core layer. The core layer 112 may be made of any material that is flexible and tear-resistant. For example, the core layer 112 may be made of polyvinyl chloride, polypropylene, polyurethane foam, or any similar material. The core layer 112 may be laminated onto or otherwise contacted to the support layer 111. The first cleaning surface 103 may be made of a soft fabric or other soft material such as a UBL fabric that is attached to the core layer 112. Other materials may include flocked material or other patterned or textured surfaces that provide a cleaning friction. The support layer 111 may be attached to the core layer 112 opposite the first cleaning surface 103. In certain embodiments, the support layer 111 may be omitted.

Such multi-layer designs allow distinct layers to retain the cleaning medium while providing mechanical resilience or frictional cleaning features, meeting varied printer maintenance needs under different usage conditions (e.g., daily vs. weekly cleaning routines).

Optionally, the cleaning tool also may include a second cleaning surface. The second cleaning surface may be formed of a fabric or another texture that provides a cleaning function. The second cleaning surface may be, or may be attached to, the support layer 111.

Optionally, the cleaning surface(s) cleaning tool may include at least one cleaning structure such as a raised surface element 105, which may be partially elevated above the top plane of the cleaning tool. Other cleaning structures such as scarification holds or flaps may be provided.

In some embodiments, either or both of the cleaning surfaces described above may be coated with the cleaning solution described in this disclosure. In some embodiments, the cleaning solution may be pre-applied to the cleaning tool, and the tool may be contained in a sealed pouch until time of use. Alternatively, the cleaning solution may be provided in a separate container and applied to the cleaning tool at the time of use.

Hereinafter, the present disclosure will be described in more detail with reference to specific Examples in comparison with Comparative Examples. However, the present disclosure is not limited to the Examples.

### Example 1

| Solvent | Adhesive Dissolved |
|---|---|
| Octane | Y |
| Propylene carbonate | N |
| Hexane | Y |
| IPA | N |
| Toluene | Y |
| Xylene | Y |
| Decane | Y |
| Mineral oil | N |
| Ethyl acetate | N |
| Ethylene glycol monopropyl ether | Y |
| DMF | Y |
| Dichloromethane | Y |
| Isopropyl acetate | Y |

The above solvents were tested to find one effective in removing adhesives from the inside of a media dispenser (e.g., linerless label printer). Propylene carbonate, IPA, mineral oil, and ethyl acetate are determined to be not suitable for removing adhesives. Octane, hexane, toluene, xylene, decane, ethylene glycol monopropyl ether, DMF, dichloromethane, and isopropyl acetate are determined to be suitable for removing adhesives.

Certain solvents (such as toluene and xylene) are well-known for their strong solvency power but may be subject to stringent handling or environmental regulations. Others (like dichloromethane or DMF) can dissolve adhesives effectively but raise concerns related to toxicity or volatility. Meanwhile, ethylene glycol monopropyl ether and isopropyl acetate balance decent solvency performance with potentially lower toxicity or odor. As a result, while these solvents can dissolve the tested adhesive residue, practical considerations-such as compliance, occupational safety, and compatibility with machine components-often guide which solvents are ultimately preferred.

### Example 2

| Solvent | Adhesive Dissolved |
|---|---|
| Formulation C | 49% Denatured ethanol |
| (Comparative | 49% Dipropylene Glycol Methyl Ether Acetate |
| Example 1) | 2% Limonene |
| Formulation D | 49% Denatured ethanol |
| (Comparative | 49% Dipropylene Glycol n-Propyl Ether |
| Example 2) | 2% Limonene |
| Formulation E | 49% denatured ethanol |
| (Comparative | 49% Tripropylene Glycol n-Butyl Ether |
| Example 3) | 2% Limonene |
| Formulation F | 49% IPA |
| (Comparative | 49% Dipropylene Glycol Methyl Ether Acetate |
| Example 4) | 2% Limonene |
| Formulation G | 49% IPA |
| (Comparative | 49% Dipropylene Glycol n-Propyl Ether |
| Example 5) | 2% Limonene |
| Formulation H | 49% IPA |
| (Comparative | 49% Tripropylene Glycol n-Butyl Ether |
| Example 6) | 2% Limonene |
| Formulation I | 24% denatured ethanol |
| (Comparative | 74% Tripropylene Glycol n-Butyl Ether |
| Example 7) | 2% Limonene |
| Formulation J | 74% denatured ethanol |
| (Comparative | 24% Tripropylene Glycol n-Butyl Ether |
| Example 8) | 2% Limonene |
| Formulation K | 49% denatured ethanol |
| (Example) | 51% Tripropylene Glycol n-Butyl Ether |
| Formulation L | 49% denatured ethanol |
| (Example) | 51% dipropylene glycol n-propyl ether |

In this example, 7 Comparative Examples (comprising Formulations C-J) are contrasted with Examples (comprising Formulations K-L) in terms of solution compatibility, cleanability, flammability, and prolonging effect.

Due to the presence of limonene and IPA, Formulations C-J are anticipated to induce swelling in natural rubber or silicone, which constitutes an internal surface of machine actuating mechanisms. In particular, Example 4 below illustrates that Comp Example 1 (Comparative Example), containing limonene, notably swells a silicone roller.

Examples such as formulation K and L possess regulatory and health and safety advantages over Comparative Examples.

These controlled experiments reflect the complex nature of adhesive removal, highlighting how certain solvents (e.g., octane, hexane) can be effective but less ideal for broad industrial compliance due to odor or flammability, whereas TGBE/ethanol blends strike a balance between performance and safety. In particular, the presence of limonene in Comparative Examples (C-J) can lead to a strong citrus-like odor, environmental disposal considerations, and adverse interactions with elastomeric materials. IPA likewise may cause rubber swelling and degrade certain printer components. By contrast, the TGBE/ethanol or DPnP/ethanol mixtures (Formulations K-L) demonstrate more stable compatibility with silicone rollers, reduced odor, and fewer regulatory hurdles, making them especially advantageous for high-throughput label printers or multi-media transport systems.

### Example 3-Composition of Tripropylene Glycol n-Butyl Ether

| | Weight | Vapor pressure |
|---|---|---|
| Component | concentration (%) | (mm Hg at 20° C.) |
| Tripropylene glycol | >95.0% | 0.002 |
| monobutyl ether | | |
| Polypropylene glycol | <4.0% | 0.0008 |
| monobutyl ether | | |
| Tripropylene glycol | <1.9% | 0.002 |
| Dipropylene glycol | <1.5% | 0.04 |
| n-butyl ether | | |

Of the four components of Tripropylene Glycol n-Butyl Ether (TGBE), the top three components: tripropylene glycol monobutyl ether, polypropylene glycol monobutyl ether, and tripropylene glycol primarily remain on the surface due to their relatively low vapor pressure. Among others, this is expected to enable the ‘prolonging effect’ by creating a protective coating on the internal surfaces that require cleaning, thereby preventing buildup of adhesive and debris.

Because tripropylene glycol monobutyl ether comprises over 95% of TGBE by weight, it largely dictates the solvent's performance characteristics-particularly its ability to dissolve adhesive residues while maintaining minimal volatility. The minor fractions of polypropylene glycol monobutyl ether, tripropylene glycol, and dipropylene glycol n-butyl ether can enhance overall solvency or tailor the solution's viscosity and drying profile. This synergistic blend is believed to form a thin residual layer on machine surfaces, effectively reducing the rate at which new adhesive deposits accumulate and thereby extending the cleaning interval.

### Example 4—Solution Compatibility Test (Swelling Test)

To assess solution compatibility with the surfaces of a machine-actuating mechanism (e.g., a printer), an internal part (e.g., a silicone roller) was completely soaked or submerged in each solution for varying durations: 30 minutes, 1 hour, 1.5 hours, and 2 hours. After each soaking time, measurements of length, width, and thickness are taken and compared with the dimensions before submersion.

1) Silicone rollers with grooves from a linerless label printer A

| | Comparative Examples | | | Examples | |
|---|---|---|---|---|---|
| | PMX-200 Silicone | 98% IPA | Formulation C | Formuation K | Formulation L |
| Soak Time 30 Min | | | | | |
| Length Before | 3.16 | 3.157 | 3.165 | 3.166 | 0.9825 |
| Length After | 3.175 | 3.161 | 3.21 | 3.166 | 0.9865 |
| Length Change % | 0.47% | 0.13% | 1.42% | 0.00% | 0.41% |
| Width/Thickness Before | 0.58 | 0.58 | 0.578 | 0.585 | 0.5800 |
| Width/Thickness After | 0.613 | 0.583 | 0.62 | 0.585 | 0.5820 |
| Width/Thickness Change % | 5.69% | 0.52% | 7.27% | 0.00% | 0.34% |
| Soak Time 1 Hour | | | | | |
| Length Before | 3.16 | 3.157 | 3.165 | 3.166 | 0.9825 |
| Length After | 3.178 | 3.162 | 3.215 | 3.169 | 0.9880 |
| Length Change % | 0.57% | 0.16% | 1.58% | 0.09% | 0.56% |
| Width/Thickness Before | 0.58 | 0.58 | 0.578 | 0.585 | 0.5800 |
| Width/Thickness After | 0.623 | 0.584 | 0.6385 | 0.5865 | 0.5840 |
| Width/Thickness Change % | 7.41% | 0.69% | 10.47% | 0.26% | 0.69% |
| Soak Time 1.5 Hours | | | | | |
| Length Before | 3.16 | 3.157 | 3.165 | 3.166 | 0.9825 |
| Length After | 3.187 | 3.1625 | 3.245 | 3.172 | 0.9900 |
| Length Change % | 0.85% | 0.17% | 2.53% | 0.19% | 0.76% |
| Width/Thickness Before | 0.58 | 0.58 | 0.578 | 0.585 | 0.5800 |
| Width/Thickness After | 0.627 | 0.5845 | 0.651 | 0.587 | 0.5850 |
| Width/Thickness Change % | 8.10% | 0.78% | 12.63% | 0.34% | 0.86% |
| Soak Time 2 Hours | | | | | |
| Length Before | 3.16 | 3.157 | 3.165 | 3.166 | 0.9825 |
| Length After | 3.2 | 3.163 | 3.248 | 3.172 | 0.9965 |
| Length Change % | 1.27% | 0.19% | 2.62% | 0.19% | 1.42% |
| Width/Thickness Before | 0.58 | 0.58 | 0.578 | 0.585 | 0.5800 |
| Width/Thickness After | 0.63 | 0.5855 | 0.658 | 0.5875 | 0.5855 |
| Width/Thickness Change % | 8.62% | 0.95% | 13.84% | 0.43% | 0.95% |

### Soak Time: 30 Minutes

During the first half hour, PMX-200 Silicone expanded in length by about 0.47% and in thickness by approximately 5.69%, indicating a moderate increase in length and relatively higher swelling in thickness. In contrast, 99% IPA produced only a 0.13% increase in length and a 0.52% increase in thickness, smaller than that of PMX-200 Silicone. Formulation C (49% Denatured ethanol, 49% Dipropylene Glycol Methyl Ether Acetate, 2% Limonene) exhibited the highest thickness change—over 7%—and a length change of 1.42%, suggesting that it swells the silicone roller more aggressively than either PMX-200 Silicone or IPA.

Meanwhile, Formulation K (51% TGBE/49% Ethanol) shows negligible dimensional change in both length and thickness (essentially 0.00% for both), revealing excellent compatibility with the silicone material. Similarly, Formulation L (51% Dipropylene Glycol n-propyl ether/49% Ethanol) shows only about 0.41% length growth and 0.34% thickness change-both of which are significantly less than the swelling from any of the comparative solvents.

### Soak Time: 1 Hour

During the first half hour, the roller soaked in PMX-200 Silicone expanded in length by about 0.47% and in thickness by approximately 5.69%, indicating a moderate increase in length and a relatively higher swelling in thickness. In contrast, 99% IPA produced only a 0.13% increase in length and a 0.52% increase in thickness, smaller than that of PMX-200 Silicone. Formulation C (49% Denatured ethanol, 49% Dipropylene Glycol Methyl Ether Acetate, 2% Limonene) exhibited the largest increase in thickness (over 7%) and a length change of 1.42%, suggesting a stronger swelling effect on the silicone roller compared to either PMX-200 Silicone or IPA.

Meanwhile, Formulation K (51% TGBE/49% Ethanol) showed negligible dimensional change in both length and thickness (essentially 0.00% for both), indicating excellent compatibility with the silicone material. Similarly, Formulation L (51% Dipropylene Glycol n-propyl ether/49% Ethanol) exhibited about 0.41% length growth and 0.34% thickness change-both significantly less than any of the comparative solvents.

### Soak Time: 1.5 Hours

By 90 minutes, PMX-200 Silicone showed a length change of about 0.85% and thickness swelling of 8.10%, underscoring that the roller kept expanding in thickness over time. Meanwhile, 99% IPA limited the silicone's growth to only 0.17% in length and 0.78% in thickness, remaining below 1% in both dimensions. Formulation C, however, reached 2.53% length swelling and a substantial 12.63% thickness increase, indicating that it had the strongest swelling effect at this timepoint.

Formulation K remained the most stable, with length and thickness changes near 0.19% and 0.34%, respectively. Formulation L also remained under 1% change, coming in at about 0.76% in length and 0.86% in thickness, less than the higher readings from PMX-200 Silicone or limonene blends.

### Soak Time: 2 Hours

At the two-hour mark, PMX-200 Silicone's swelling in thickness remained high (8.62%), while its length grew about 1.27%. Meanwhile, 99% IPA showed a minimal length increase of roughly 0.19% and a moderate thickness expansion of 0.96%. Formulation C exhibited a 2.62% length increase and 13.84% thickness swelling, the largest change of all products tested at this timepoint.

Formulation K exhibited excellent compatibility, with only 0.22% length growth and 0.43% thickness swelling. Formulation L showed a slightly higher length change of 1.42% but kept its thickness change at about 0.95%, which is still far below Formulation C or PMX-200 Silicone.

In summary, for printer A, Formulation K exhibited negligible swelling at virtually every timepoint, whereas Formulation L remained consistently low as well. The comparative solutions-particularly PMX-200 Silicone and Formulation C-induced much larger expansions in thickness over time, indicating how Formulations K and L are more silicone-friendly than the polydimethylsiloxane fluid or limonene/IPA comparisons.

2) Red silicone roller from a linerless label printer B

| | Comparative Examples | | Examples | |
|---|---|---|---|---|
| | PMX-200 Silicone | 99% IPA | Formuation K | Formulation L |
| Soak Time 30 Min | | | | |
| Length Before | 1.374 | 1.466 | 1.379 | 1.3900 |
| Length After | 1.385 | 1.466 | 1.379 | 1.3917 |
| Length Change % | 0.80% | 0.00% | 0.00% | 0.12% |
| Width/Thickness Before | 0.555 | 0.555 | 0.555 | 0.5550 |
| Width/Thickness After | 0.562 | 0.555 | 0.555 | 0.5552 |
| Width/Thickness Change % | 1.26% | 0.00% | 0.00% | 0.04% |
| Soak Time 1 Hour | | | | |
| Length Before | 1.374 | 1.466 | 1.379 | 1.3900 |
| Length After | 1.393 | 1.466 | 1.379 | 1.3935 |
| Length Change % | 1.38% | 0.00% | 0.00% | 0.25% |
| Width/Thickness Before | 0.555 | 0.555 | 0.555 | 0.5550 |
| Width/Thickness After | 0.567 | 0.556 | 0.555 | 0.5556 |
| Width/Thickness Change % | 2.16% | 0.18% | 0.00% | 0.11% |
| Soak Time 1.5 Hours | | | | |
| Length Before | 1.374 | 1.466 | 1.379 | 1.3900 |
| Length After | 1.40 | 1.467 | 1.379 | 1.3940 |
| Length Change % | 1.89% | 0.07% | 0.00% | 0.29% |
| Width/Thickness Before | 0.555 | 0.555 | 0.555 | 0.5550 |
| Width/Thickness After | 0.569 | 0.556 | 0.555 | 0.5560 |
| Width/Thickness Change % | 2.52% | 0.18% | 0.00% | 0.18% |
| Soak Time 2 Hours | | | | |
| Length Before | 1.374 | 1.466 | 1.379 | 1.3900 |
| Length After | 1.455 | 1.469 | 1.382 | 1.3942 |
| Length Change % | 5.90% | 0.20% | 0.22% | 0.30% |
| Width/Thickness Before | 0.555 | 0.555 | 0.555 | 0.5550 |
| Width/Thickness After | 0.571 | 0.557 | 0.556 | 0.5560 |
| Width/Thickness Change % | 2.88% | 0.36% | 0.18% | 0.18% |

### Soak Time: 30 Minutes

After thirty minutes, PMX-200 Silicone expanded the roller's length by about 0.80% and thickness by 1.26%. In contrast, 99% IPA showed no measurable change (0.00% in length and thickness), effectively matching the near-perfect compatibility of Formulation K, which also showed 0.00% swelling in both dimensions. Formulation L displayed a small 0.12% rise in length and a 0.04% increase in thickness, outperforming PMX-200 Silicone but slightly higher than Formulation K or IPA.

### Soak Time: 1 Jour

By the one-hour mark, PMX-200 Silicone increased the silicone roller's length to about 1.38% and thickness to roughly 2.16%. The 99% IPA remained low, at 0.00% length change and about 0.18% thickness.

Formulation K posted effectively zero swelling. Formulation L increased a little, reaching 0.25% length growth and 0.11% thickness growth, which is still below PMX-200 Silicone's results.

### Soak Time: 1.5 Hours

At ninety minutes, PMX-200 Silicone reached around 1.89% in length and 2.52% in thickness, indicating a continued steady rise. 99% IPA experienced a modest 0.07% length increase and 0.18% thickness increase, comparable to earlier intervals.

Formulation K again showed negligible swelling, holding at 0.00% for both dimensions. Formulation L rose to about 0.29% length and 0.18% thickness, well under one-third of PMX-200 Silicone's swelling.

### Soak Time: 2 Hours

After two hours, PMX-200 Silicone reached 5.90% length change, while thickness grew 2.88%. In contrast, 99% IPA was near 0.20% length and 0.36% thickness, indicating moderate but still relatively low swelling.

Formulation K increased to about 0.22% length change but remained at 0.00% in thickness. Formulation L measured 0.30% length change and 0.95% thickness swelling, which is higher than Formulation K's thickness change but still far below the nearly 6% length growth observed for PMX-200 Silicone.

Overall, printer B's red silicone roller showed higher sensitivity to PMX-200 Silicone, particularly in length change, while Formulation K and Formulation L had minimal effects. IPA performed fairly well in the first 90 minutes but was higher than Formulation K in thickness swelling at the final timepoint.

3) Grey silicone roller from a linerless label printer C

| | Comparative Examples | | Examples | |
|---|---|---|---|---|
| | PMX-200 Silicone | 99% IPA | Formuation K | Formulation L |
| Soak Time 30 Min | | | | |
| Length Before | 1.095 | 1.04 | 0.975 | 1.00 |
| Length After | 1.11 | 1.055 | 0.9755 | 1.013 |
| Length Change % | 1.37% | 1.44% | 0.05% | 1.30% |
| Width/Thickness Before | 0.49 | 0.49 | 0.49 | 0.502 |
| Width/Thickness After | 0.506 | 0.4925 | 0.491 | 0.503 |
| Width/Thickness Change % | 3.27% | 0.51% | 0.20% | 0.20% |
| Soak Time 1 Hour | | | | |
| Length Before | 1.095 | 1.04 | 0.975 | 1.00 |
| Length After | 1.13 | 1.06 | 0.981 | 1.018 |
| Length Change % | 3.20% | 1.92% | 0.62% | 1.80% |
| Width/Thickness Before | 0.49 | 0.49 | 0.49 | 0.503 |
| Width/Thickness After | 0.515 | 0.492 | 0.492 | 0.504 |
| Width/Thickness Change % | 5.10% | 0.41% | 0.41% | 0.20% |
| Soak Time 1.5 Hours | | | | |
| Length Before | 1.095 | 1.04 | 0.975 | 1.00 |
| Length After | 1.14 | 1.06 | 0.9875 | 1.02 |
| Length Change % | 4.11% | 1.92% | 1.28% | 2.00% |
| Width/Thickness Before | 0.49 | 0.49 | 0.49 | 0.503 |
| Width/Thickness After | 0.523 | 0.495 | 0.494 | 0.504 |
| Width/Thickness Change % | 6.73% | 1.02% | 0.82% | 0.20% |
| Soak Time 2 Hours | | | | |
| Length Before | 1.095 | 1.04 | 0.975 | 1.00 |
| Length After | 1.16 | 1.06 | 0.9875 | 1.023 |
| Length Change % | 5.94% | 1.92% | 1.26% | 2.30% |
| Width/Thickness Before | 0.49 | 0.49 | 0.49 | 0.503 |
| Width/Thickness After | 0.527 | 0.4985 | 0.494 | 0.5045 |
| Width/Thickness Change % | 7.55% | 1.73% | 0.82% | 0.30% |

### Soak Time: 30 Minutes

Within the first 30 minutes, PMX-200 Silicone increased length by about 1.37% and thickness by 3.27%, indicating moderate length growth but a relatively larger initial jump in thickness. By comparison, 99% IPA produced a similar length change of 1.44% yet only 0.51% thickness swelling, suggesting it was more contained in the thickness dimension

Formulation K showed exceptionally low swelling, at around 0.05% length and 0.20% thickness, whereas Formulation L exhibited a 1.30% length change but only 0.20% thickness growth.

Thus at 30 minutes, Formulation K was the lowest in swelling among the four, while Formulation L's length change was comparable with IPA, though its thickness change remained very low.

### Soak Time: 1 Hour

After an hour, PMX-200 Silicone's thickness rose to 5.10%, and its length to around 3.20%, reflecting continued swelling. 99% IPA increased length by 1.92% with a 0.41% thickness change, so it remained moderate in its overall effect.

Formulation K registered about 0.62% length change and 0.41% thickness, still quite low relative to PMX-200 Silicone. Formulation L was at 1.80% length and 0.20% thickness, a combination that was slightly higher in length than Formulation K but noticeably lower in thickness.

### Soak Time: 1.5 Hours

By 90 minutes, PMX-200 Silicone increased again to 4.11% length and 6.73% thickness, indicating a significant increase. The 99% IPA remained near 1.92% length change and grew to about 1.02% thickness change, up from 0.41% at the previous interval.

Formulation K rose modestly to about 1.28% in length and 0.82% in thickness, well under half of PMX-200 Silicone's thickness results. Formulation L reached 2.00% in length and 0.20% in thickness, which suggests the length expansion was somewhat higher than Formulation K's, but thickness remained very low at just 0.20%.

### Soak Time: 2 Hours

At the two-hour mark, PMX-200 Silicone exhibited 5.94% length change and 7.55% thickness change, the highest swelling in thickness recorded for Printer C. 99% IPA was at 1.92% in length and 1.73% in thickness, which was less than PMX-200's swelling but significantly higher than the example formulations.

Formulation K limited the roller to 1.28% length change and only 0.49% thickness change, reflecting relatively low impact. Formulation L showed 2.30% length change and 0.30% thickness change, slightly higher in length than Formulation K but still well below the ˜7.5% thickness observed with PMX-200 Silicone.

Overall, printer C's gray silicone roller was more prone to swelling in general, but Formulation K and Formulation L limited the change to a fraction of what PMX-200 Silicone and IPA produced, especially in thickness.

4) Blue silicone roller from a linerless label printer D

| | Comparative Examples | | Examples | |
|---|---|---|---|---|
| | PMX-200 Silicone | 99% IPA | Formuation K | Formulation L |
| Soak Time 30 Min | | | | |
| Length Before | 1.3 | 1.275 | 1.29 | 1.305 |
| Length After | 1.313 | 1.285 | 1.295 | 1.306 |
| Length Change % | 1.00% | 0.78% | 0.39% | 0.08% |
| Width/Thickness Before | 0.5 | 0.4975 | 0.498 | 0.500 |
| Width/Thickness After | 0.509 | 0.503 | 0.502 | 0.501 |
| Width/Thickness Change % | 1.80% | 1.11% | 0.80% | 0.20% |
| Soak Time 1 Hour | | | | |
| Length Before | 1.3 | 1.275 | 1.29 | 1.305 |
| Length After | 1.32 | 1.283 | 1.302 | 1.308 |
| Length Change % | 1.54% | 0.63% | 0.93% | 0.23% |
| Width/Thickness Before | 0.5 | 0.4975 | 0.498 | 0.500 |
| Width/Thickness After | 0.527 | 0.504 | 0.505 | 0.502 |
| Width/Thickness Change % | 5.40% | 1.31% | 1.41% | 0.40% |
| Soak Time 1.5 Hours | | | | |
| Length Before | 1.3 | 1.275 | 1.29 | 1.305 |
| Length After | 1.324 | 1.287 | 1.304 | 1.310 |
| Length Change % | 1.85% | 0.94% | 1.09% | 0.38% |
| Width/Thickness Before | 0.5 | 0.4975 | 0.498 | 0.500 |
| Width/Thickness After | 0.535 | 0.5065 | 0.502 | 0.503 |
| Width/Thickness Change % | 7.00% | 1.81% | 0.80% | 0.60% |
| Soak Time 2 Hours | | | | |
| Length Before | 1.3 | 1.275 | 1.29 | 1.305 |
| Length After | 1.33 | 1.288 | 1.293 | 1.310 |
| Length Change % | 2.31% | 1.02% | 0.23% | 0.38% |
| Width/Thickness Before | 0.5 | 0.4975 | 0.498 | 0.500 |
| Width/Thickness After | 0.535 | 0.507 | 0.502 | 0.505 |
| Width/Thickness Change % | 7.00% | 1.91% | 0.80% | 1.00% |

### Soak Time: 30 Minutes

At 30 minutes, PMX-200 Silicone resulted in a 1.00% length increase and a 1.80% thickness change, while 99% IPA exhibited 0.78% length and 1.11% thickness.

Formulation K showed around 0.39% length and 0.80% thickness, remaining below IPA's swelling and well below PMX-200 Silicone in terms of thickness. Formulation L recorded extremely low changes at around 0.08% length and 0.20% thickness, making it the most stable of the four products at this initial timepoint.

### Soak Time: 1 Hour

After one hour, PMX-200 Silicone's thickness rose to 5.40%, while its length reached 1.54%. Meanwhile, 99% IPA showed around 0.63% length growth and 1.31% thickness growth, which was notably lower than PMX-200 but still relatively significant.

Formulation K registered 0.93% in length and 1.41% in thickness, which is less than PMX-200 Silicone but slightly higher in thickness than IPA at this interval. Formulation L remained much lower at about 0.23% in length and 0.40% in thickness.

### Soak Time: 1.5 Hours

At 90 minutes, PMX-200 Silicone reached 1.85% length swelling and 7.00% thickness swelling, indicating a significant expansion. By comparison, 99% IPA reached 0.94% length and 1.81% thickness, which remained considerably below PMX-200.

Formulation K rose modestly to 1.09% length and 1.41% thickness, while Formulation L was 0.38% length and 0.60% thickness.

Here, Formulation K fell between the swelling levels of IPA and PMX-200 Silicone, whereas Formulation L remained below both.

### Soak Time: 2 Hours

At two hours, PMX-200 Silicone had a 2.31% length change and remained near 7.00% thickness change, which was the highest thickness among the four solutions. 99% IPA was around 1.02% length and 1.91% thickness, indicating moderate swelling.

Formulation K decreased to about 0.23% length swelling and 1.00% thickness swelling, both well below IPA or PMX-200. Formulation L exhibited 0.38% length change and 1.00% thickness change, similar to Formulation K at this stage and still markedly under the ˜7% thickness observed with PMX-200 Silicone.

Printer D's blue silicone roller exhibited the greatest thickness swelling when exposed to PMX-200 Silicone; IPA was more moderate, and both Formulations K and L stayed well under 2% swelling in any dimension, with Formulation L often showing especially low swelling, especially at the shorter timepoints.

PMX-200 Silicone routinely induced significant swelling-particularly in thickness across all four printers, often exceeding 5-7% or more by the two-hour mark and sometimes increasing further in the second hour. In contrast, 99% IPA generally caused less swelling than PMX-200 Silicone but could still approach or exceed 1-2% thickness changes after extended submersion, showing that it was gentler yet not as mild as the new example blends. Additionally, limonene-containing formulations (e.g., Formulation C) exhibited thickness changes above 10% in some cases, demonstrating that limonene had a relatively large impact on silicone rollers.

By comparison, Formulation K (51% TGBE/49% Ethanol) consistently exhibited the lowest or near-lowest swelling figures, typically remaining under 1% in both length and thickness at most soak times, and often remaining near zero. Formulation L (51% Dipropylene Glycol n-propyl ether/49% Ethanol) likewise exhibited very low swelling, occasionally rising a bit more in length than K but still much lower than IPA or PMX-200 Silicone in thickness changes.

In sum, Formulations K and L provided significantly improved silicone compatibility than the comparative solutions, resulting in minimal dimensional changes even after two hours of soaking-indicating that a TGBE-ethanol or DPnP-ethanol blend can be highly advantageous for cleaning label printers and other devices with silicone rollers, especially compared to PMX-200 Silicone, IPA alone, or limonene-type solvents.

While the specific embodiments of the present disclosure have been illustrated and described, it will be obvious to those skilled in the art that the present disclosure may be variously modified and changed without departing from the technical spirit of the present disclosure defined in the appended claims.

It should be understood that variations, clarifications, or modifications are contemplated. Applications of the technology to other fields not mentioned are also contemplated.

Example methods and compositions are described. Since numerous modifications and changes will readily be apparent to those having ordinary skill in the art, it is not desired to limit the present disclosure to only the exact constructions as demonstrated in this disclosure. Accordingly, all suitable modifications and equivalents may be resorted to falling within the scope of the present disclosure.

Thus, for example, any sequence(s) and/or temporal order of steps of various processes or methods that are described herein are illustrative and should not be interpreted as being restrictive except as it would be generally understood from the context and description. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present disclosure.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present disclosure.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that for example may involve multiple possibilities, but to a person of ordinary skill in the art a reasonable or primary understanding or meaning is understood.

Unless defined otherwise, all technical and scientific terms used herein have same meaning as commonly understood by the person of ordinary skill in the art to which this disclosure belongs.

Embodiments of the present disclosure can include methods and/or compositions.

It should be understood that the above description of the present disclosure and specific examples, while indicating preferred embodiments of the present disclosure, are given by way of illustration and not limitation. Many changes and modifications within the scope of the present disclosure may be made without departing from the spirit thereof, and the present disclosure includes all such changes and modifications.

What is claimed is:

1. A cleaning medium for removing adhesive, the cleaning medium comprising:
ethanol; and
tripropylene glycol n-butyl ether (TGBE).

2. The cleaning medium of claim 1, wherein the TGBE is present in an amount of about 50-70% by weight based on the total weight of the cleaning medium.

3. The cleaning medium of claim 1, wherein the ethanol is present in an amount of about 30-50% by weight based on the total weight of the cleaning medium.

4. The cleaning medium of claim 1, wherein the TGBE is present in an amount of about 51% by weight and the ethanol is present in an amount of about 49% by weight based on the total weight of the cleaning medium.

5. The cleaning medium of claim 1, wherein an amount of the TGBE is more than an amount of the ethanol by weight.

6. The cleaning medium of claim 1, wherein the cleaning medium further comprises propylene glycol monobutyl ether and tripropylene glycol.

7. The cleaning medium of claim 6, wherein the cleaning medium further comprises dipropylene glycol n-butyl ether.

8. The cleaning medium of claim 7, wherein the TGBE is present in an amount of more than about 95% by weight based on a total weight of the TGBE, propylene glycol monobutyl ether, tripropylene glycol, and dipropylene glycol n-butyl ether.

9. The cleaning medium of claim 1, being free of limonene, isopropyl alcohol (IPA), or silicone.

10. The cleaning medium of claim 1, being substantially free of limonene, isopropyl alcohol (IPA), or silicone.

11. The cleaning medium of claim 1, wherein the cleaning medium consists essentially of:
ethanol; and
tripropylene glycol n-butyl ether (TGBE).

12. A method of cleaning a label printer, the method comprising:
treating a cleaning substrate with a cleaning solution comprising ethanol and tripropylene glycol n-butyl ether (TGBE);
inserting the treated cleaning substrate into a transport path of the label printer so as to come into contact with at least one internal surface when the printer is activated;
activating the label printer to cause the at least one internal surface to contact the treated substrate; and
removing the cleaning substrate from the transport path.

13. The method of claim 12, further comprising repeating the activating step at additional locations on the cleaning substrate to enhance contact between the internal surface and the cleaning solution as the substrate moves along the transport path.

14. The method of claim 13, further comprising sensing a condition of the label printer after removing the cleaning substrate to determine whether adhesive residue remains on the at least one internal surface, and repeating the treating, inserting, and activating steps if adhesive residue is detected.

15. The method of claim 14, wherein the TGBE is present in the cleaning solution in an amount of about 50-70% by weight and the ethanol is present in the cleaning solution in an amount of about 30-50% by weight, based on a total weight of the cleaning solution.

16. A cleaning tool for use in cleaning internal surfaces of a machine-actuating mechanism intended to receive an operating card or other machine-operating substrates, the cleaning card comprising:
a cleaning substrate impregnated, coated, treated or saturated with or including a cleaning medium,
wherein the cleaning medium comprises ethanol and tripropylene glycol n-butyl ether (TGBE).

17. The cleaning card of claim 16, wherein the TGBE is present in an amount of about 50-70% by weight based on the total weight of the cleaning medium.

18. The cleaning card of claim 16, wherein the ethanol is present in an amount of about 30-50% by weight based on the total weight of the cleaning medium.

19. The cleaning card of claim 16, wherein the cleaning medium further comprises propylene glycol monobutyl ether and tripropylene glycol.

20. The cleaning card of claim 19, wherein the cleaning medium further comprises dipropylene glycol n-butyl ether.
